(19) United States
(12) Patent Application Publication
(10) Pub. No.: US 2025/0125974 A1
(43) Pub. Date: Apr. 17, 2025

(54) SYSTEMS AND METHODS FOR DIGITAL DATA OBJECT SECURE CUSTODY

(71) Applicant: ROYAL BANK OF CANADA, Toronto (CA)

(72) Inventors: Karim Talal HAMASNI, Toronto (CA); Ian SINCLAIR, Toronto (CA); Andre MAGALHAES, Ottawa (CA); Matthew Thomas PESKETT, Toronto (CA); Felipe PRIULI, Toronto (CA)

(21) Appl. No.: 18/917,947

(22) Filed: Oct. 16, 2024

Related U.S. Application Data
(60) Provisional application No. 63/544,355, filed on Oct. 16, 2023.

(51) Int. Cl. H04L 9/32

(52) U.S. Cl. CPC H04L 9/3247

(57) ABSTRACT

An improved approach for the securement of digital objects is proposed, that, as described in various embodiments, can include increased levels of encryption, air-gap segregation, and redundancy for interaction with secure approved client withdrawal addresses. A combination of computational and physical securement approaches are described that provide a practical mechanism for improving security of transactions that are conducted using cryptographic systems that addresses security vulnerabilities related to uncontrolled transaction flow. Specifically, methods are proposed for implementation on computing devices which interact with a two-part air-gapped system that is adapted to control both a secure address approval process, and a withdrawal process to the approved address. These processes operate in combination.

### CROSS-REFERENCE

This application is a non-provisional of, and claims all benefit, including priority to: U.S. Application No. 63/544,355, filed Oct. 16, 2023, entitled SYSTEMS AND METHODS FOR DIGITAL DATA OBJECT SECURE CUSTODY, incorporated herein by reference.

### FIELD

Embodiments of the present disclosure relate to the field of secure inter-process communication, transport and storage of data object representations and more specifically, embodiments relate to devices, systems and methods for secure inter-process communication, transport and storage of data objects representing digital assets using a specially configured offline system.

### INTRODUCTION

While digital assets provide improved opportunities for efficient transfer, digital assets, due to their underlying technical design and infrastructure, have increased vulnerability to cybersecurity vectors.

In particular, digital assets are typically sent to various cryptographic addresses, such as a digital wallet address. A digital wallet address can be a randomly generated set of numbers and/or letters, and can be accessible through the use of various types of corresponding cryptographic keys.

A benefit of using digital wallets is that they can have high availability and be easily modified, for example, conducting interactions through an application programming interface (API) or a command line interpreter (CLI) that can be interacted at through various computing nodes.

Unlike physical assets, digital assets can be transacted or moved using digital instructions only, and while this means that the transfers can be conveniently conducted, there is also a high loss potential from a successful cyberattack.

### SUMMARY

An improved approach for the processing, transport and storage of data objects is proposed, that, as described in various embodiments, can include increased levels of encryption, air-gap segregation, and redundancy for interaction with secure approved client withdrawal addresses.

The proposed system is structurally provided as a physical combination of an internet-connected system (the “portal” system) and an air-gapped, offline system (the “vault” system). The systems are configured to interoperate with one another only with communication limitations, and thus improve cybersecurity by reducing the available attack vectors. A backend certificate authority can be provided (e.g., the root certificate authority) as an additional securement mechanism for communication protocols between the portal system and the vault system.

The communications can be limited between one another, for example, using a combination of physical communication pathways, such as the requirement of a photographic or graphical code being utilized, such as a QR code. Using the QR codes necessitates the use of digital signatures to validate the messages. The root certificate authority is used to produce a digital signature for all messages sent from the portal system to the vault system. The physical combination allows for an improved set of hybrid digital/physical security measures, reducing overall cybersecurity vectors but also adding additional operational complexity.

The signature enables the offline vault system to validate that all messages it receives were authored by the portal system, and not by a third-party. This protects against a man-in-the-middle attack wherein a communication is intercepted and altered to potentially direct digital assets to an attacker's wallet.

Two data processes are proposed that can interoperate with one another, a first data process that is configured to update a client's list of approved withdrawal addresses, and a second data process that uses the list from the first process to process client transactions (e.g., withdrawals).

In the first data process, a computational approach is proposed that allows a message to be signed by the portal system to detail a proposed addition to a client's list of approved withdrawal addresses, which can be printed on a QR code and taken to a vault for validation using a hardware security module (“HSM”) on the vault system.

In the second data process, the portal system can be used to receive a data message corresponding to a client withdrawal. The portal system exposes previously approved withdrawal addresses as interactive interface elements, and these are used for validation against message digital signatures, and an encrypted address that is decrypted by the HSM and compared against an address in a withdrawal request.

For increased redundancy, the HSM, in some embodiments, can be configured for recovery of the encryption keys, for example, using specific approaches during the initialization of the HSM for backup or redundancy.

The portal and vault systems each consist of a computing device having an HSM, one or more processors, one or more memory storage devices, and a physical optical scanner device for scanning a graphical object.

The portal and vault systems are configured to be physically separated by an “air gap” such that the vault system is not connected to any network or electronic communication pathway. The portal system and vault system are configured to interoperate to process an approval or withdrawal request.

When processing an approval or withdrawal request, the portal system is configured to validate the client identifier associated with the request, digitally sign the request, and embed a digital certificate from a certificate authority within the data message. These virtual security measures are then augmented by the physical security measures provided by the air gap, such that any interoperation between the portal and vault system requires physical handling of the request to deliver it to the vault system.

The vault system is configured to scan and verify the request and authenticate the digital signature generated by the portal system. The vault system consists of a processor and HSM which can retrieve the data message within the request and perform a look up within a local dictionary data storage component within the HSM for matching data object. The vault system may consist of an output which can generate a response data object which can be digitally signed and transported to the portal system for broadcasting to one or more blockchain nodes.

In some embodiments, the data message may be a digitally signed request or response graphical object, such as a quick response (QR) code. The QR code can be scanned by one or more physical optical scanners that are coupled to the portal and vault systems.

The data message request from the portal system may include at least a user identifier and wallet address. The user identifier and wallet address can be used by the HSM housed within the vault system to look up a matching hashed key set, the hashed key set having an associated value. The associated value may be an encrypted public key which can be compared against the wallet address received in the data message request to identify a match. The wallet address received in the data message may be a pre-generated public key which forms a part of a branching wallet structure, the branching wallet structure having a master key stored within the HSM of the vault system which can be used for identifying matching addresses.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is an example block schematic diagram of a system, according to some embodiments, that is provided as a combination of an internet-connected system (the “portal” system) and an air-gapped, offline system (the “vault” system).

FIG. 2 is an example diagram showing an example secure address approval process, according to some embodiments.

FIG. 3 is an example diagram showing an example withdrawal process, according to some embodiments.

FIG. 4 is a diagram showing an example computer server that can be used to perform steps described in various embodiments herein.

FIG. 5 is an example screenshot of an example dashboard, according to some embodiments.

FIG. 6 is an example screenshot of an example approach for generating a deposit address, according to some embodiments.

FIG. 7 is a screenshot of example QR codes generated for interaction with the vault server, according to some embodiments.

FIG. 8 is an example process diagram for a process that can be conducted on the vault system, according to some embodiments.

FIG. 9 is an example JSON dictionary data structure, according to some embodiments.

### DETAILED DESCRIPTION

An improved approach for the securement of digital objects is proposed, that, as described in various embodiments, can include increased levels of encryption, air-gap segregation, and redundancy for interaction with secure approved client withdrawal addresses. A combination of computational and physical securement approaches are described that provide a practical mechanism for improving security of transactions that are conducted using cryptographic systems that addresses security vulnerabilities related to uncontrolled transaction flow. Specifically, methods are proposed for implementation on computing devices which interact with a two-part air-gapped system that is adapted to control both a secure address approval process, and a withdrawal process to the approved address. These processes operate in combination.

The interplay between air-gapped systems can be used to prevent man-in-the-middle type attacks. The processes are used to establish a process whereby transactions can only be conducted with whitelisted addresses that are pre-registered. A portal system is used to print unsigned transactions, which are then brought to an air gapped vault system by an administrator for processing. The vault system can be configured to conduct additional verification before signing the transaction and processing the transaction, for example, by broadcasting the transaction and awaiting confirmations.

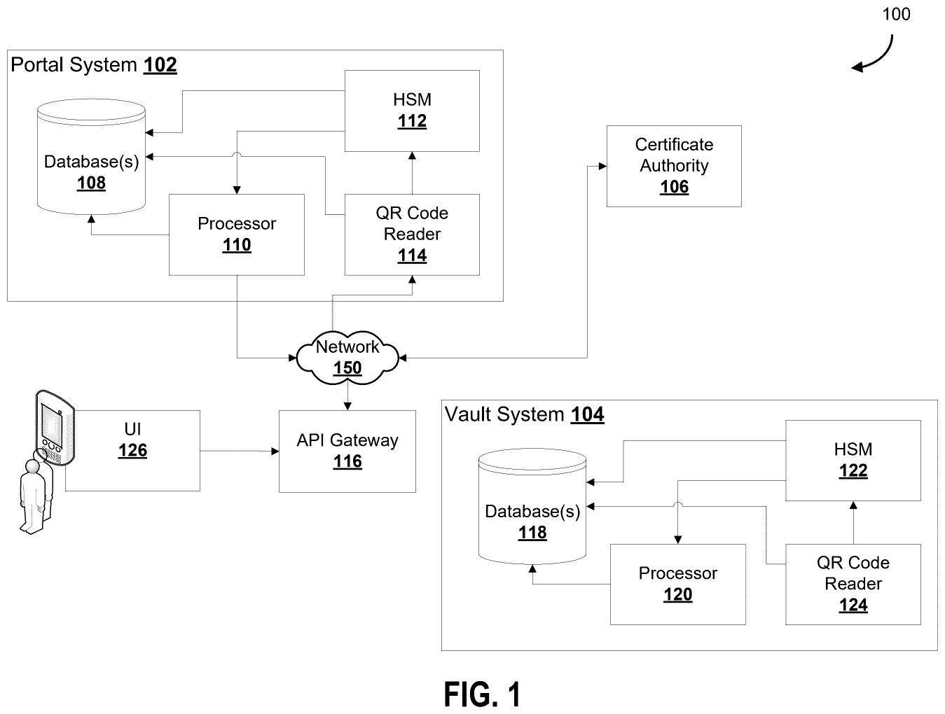

Referring to FIG. 1, FIG. 1 is an example block schematic diagram of a system, according to some embodiments, that is provided as a combination of an internet-connected system (the “portal” system 102) and an air-gapped, offline system (the “vault” system 104).

The systems 102 and 104 can be computer servers or computers, such as personal computers. The computer systems include computer processors 110 and 120 operating in conjunction with computer memory 108 and 118, and the computer systems operate using software or embedded firmware.

The two systems 102 and 104 are physically and virtually separate, and the system 104 contains restricted network interfaces to outside networks. In some embodiments, system 104 may have no external network connections. In another embodiment, system 104 may have limited or switched off external network connections. Due to the physical and virtual separation, systems 102 and 104 may be unable to communicate directly without an intermediary to transport a data message between the two systems. Systems 102 and 104 can interoperate through a physical interaction in which a copy of a data message is transferred from system 102 to system 104 (or vice versa) by a carrier who must transport a graphical data object containing the data message from one of system 102 or 104 and transfer the data to corresponding system 102 or 104 through a QR code reader 114 and 124.

In some embodiments, system 102 and 104 may be configured for handling withdrawal requests from a first virtual wallet address to a second virtual wallet address.

System 102 and 104 are configured to generate a signed request encoded graphical object (such as but not limited to, and further referred to, as a QR code). System 102 and 104 may be further configured to scan a QR code through a scanner 114 and 124 and verify the QR code by ensuring that a digital signature is embedded within the scanned data message.

In some embodiments, a data message may be physically transferred from system 102 and system 104 through a removable storage medium, including but not limited to a QR code, removable disk, a USB flash drive and memory cards.

System 102 and 104 are configured to approve and process transactions between two parties while minimizing the quantity of attack vectors which could compromise the transaction environment. Further, system 104 is configured to maintain an approved list of withdrawal addresses which are encrypted. The encrypted addresses are protected from external modification unless certain security protocols are satisfied.

The augmented security that is provided by the interoperation of system 102 and 104 may be achieved through the combination of physical and computer generated security measures which require a human operator to interact with both system 102 and 104 in separate, but verifiable, interactions through a physical medium.

The systems 102 and 104 include hardware security modules (HSM) 112 and 122, which are special computing devices provided thereon that manage and safeguard various encryption keys, limiting access and controlling usage for functions such as encryption functions, signature generation, signature verification, among others. Additional features may be included in the HSMs 112 and 122, such as tamper resistance/tracking, among others. The systems 102 and 104 are configured to interoperate with one another only with communication limitations, and thus improve cybersecurity by reducing the available attack vectors. A backend certificate authority server 106 can be provided (e.g., the root certificate authority) as an additional securement mechanism for communication protocols between the portal system and the vault system. As described in various embodiments below, specific approaches for limited interoperation are proposed.

In some embodiments, HSM 112 can store a portal private key and the corresponding public key can be provided to system 104 for encrypting the response data message for approving transactions using the withdrawal address. In this embodiment, the HSM 122 can store within a secure data storage medium the private keys required to authorize a requested transaction.

In some embodiments, the HSM 122 has a stricter level of security than the HSM 112 (i.e. more encryption bits/strong encryption). The HSM 112 can be configured to store a digital certificate generated by the certificate authority 106 using the certificate authority's 106 private key that can be used to sign a data message. The HSM 122 may also store a certificate authority 106 public key that is used to validate the digital certificate, a message digest generated by the digital certificate, or a signed object from the digital certificate as part of any of the validation processes described herein. In a further embodiment, the HSM 122 is configured to store a portion of the local dictionary storing whitelisted addresses.

The communications can be limited between devices 102, 104, 106, for example, using a combination of physical communication pathways, such as the requirement of a photographic or graphical code being utilized, such as a QR code 108. Using the QR codes 108 necessitates the use of digital signatures to validate the messages. The root certificate authority from 106 is used to produce a digital signature for all messages sent from the portal system to the vault system 104.

System 102 and 104 is coupled to a QR code reader or optical scanner 114 and 124 which is configured to be handled by a user. The scanner 114 and 124 can scan the graphical object (i.e. QR code) and transmit the embedded data message and verification information to the systems 102 and 104 for processing.

In some embodiments, scanner 114 and 124 may be configured to scan digital copies of the QR code which are displayed on a user device.

In some embodiments, systems 102 and 104 comprise one or more processors 110 and 120, which are configured to be coupled to the HSM 112 and 122. Processors 110 and 120 may be configured to generate data messages containing instructions for systems 102 and 104. These instructions may include approval requests, transaction requests, approval responses and transaction responses. Request messages generated by processor 110 may comprise instructions received through a user interface 126 to validate and/or initialize a wallet address. Response messages generated by processor 120 may comprise instructions for system 102 which verifies that a wallet address has been registered or that a wallet address is valid for a transaction.

In some embodiments, system 104 is stored within a secure location which is physically separate from the location at which a user may interact with system 102. The physical separation ensures that access to system 104 presents a further barrier to fraudulent or malicious actors seeking to compromise transactions.

Interoperation between system 102 and 104 requires a physical transfer of data which must occur external of any wired or wireless connection with external networks. A complete physical isolation between system 102 and 104 ensures that system 104 is not connected to a network that would open it up to attack vectors. Any data transfers occurring between system 102 and 104 must occur through a physical transfer of data through an external memory device which has embedded within it a secure data message that may be signed by the certificate authority 106. Any tampering with the secure data message and corresponding signature will be identified and result in the data message being rejected.

In some embodiments, system 104 may be encapsulated by a Faraday cage or similar protective environment which restricts electromagnetic leakage from being accessible by external parties.

By inserting an air gap that encapsulates system 104, a vault like security system is created where access requires a physical presence near the system and a verified input which has been digitally signed to restrict modification post-generation. The combination of the physical and digital security measures remove the ability for a malicious actor to gain access to potentially lower security networks and use that as an avenue to infiltrate the vault system 104.

Certain specialized equipment such as physical optical scanners 114 and 124 paired with HSM 112 and 122, and a certificate authority 106 are configured to operate as security measures which would not typically be present within a traditional data messaging environment. By requiring physical transfer of data messages within graphical object data structures, and pairing that with the requirement that digital signatures must be verified in order to access the vault system 104, the possible threat vectors may be substantially reduced.

The air gap between system 104 and 102 may be segregated through combinations of physical, logical and isolated air gapping. Preferably, a total physical air gap is present and the vault system 104 is isolated from all networked connections and has physical access controls implemented to restrict physical access by unauthorized individuals.

The signature enables the offline vault system 104 to validate that all messages it receives were authored by the portal system, and not by a third-party. This protects against a man-in-the-middle attack wherein a communication is intercepted and altered to potentially direct digital assets to an attacker's wallet.

For example, when system 102 generates an initial graphical object for transport to system 104, the graphical object may contain multiple virtual security mechanisms which can be validated by system 104 to ensure that the data object has not been tampered with. These virtual security mechanisms operate in tandem with the physical security measures provided by the air gapped interoperation of system 102 and 104.

In this example, when system 102 initiates communication with system 104, a graphical object for storing a data message is generated which is used for system initialization. System 102 generates a data message which contains a system identifier. The data message may be embedded with a public key and digital certificate generated by certificate authority 106. Digital certificate may bind the system identifier and public key together. This initial digital certificate may be a root certificate which establishes secure communication between system 102 and 104.

System 104 may scan this system initialization data message and retrieve the public key which is bound with system 102. The public key bound with system 102 may be stored within HSM 122 of system 104 and used to validate all digital signatures from system 102. The digital certificate may be time limited and therefore contain an expiry date upon which a new digital certificate will need to be generated by certificate authority 106 and transported to system 104.

Once the system has been initialized, future data messages generated by system 102 may be authenticated by certificate authority 106 with a digital certificate and signature which validates that the data message was generated by system 102. Certificate authority 106 may digitally sign all data messages to allow system 104 to validate that the data message has not been tampered with during transport to system 104.

In some embodiments, system 102 and 104 are configured to validate the data messages by verifying that a graphical object contains a digital certificate corresponding to a digital certificate generated by the certificate authority 106. The digital certificate generated by the certificate authority 106 may include authentication of the identity of the sending party (i.e. the portal system 102) and a digital signature associated with the sending party.

System 102 and certificate authority 106 may be configured to communicate through cloud based network 150. In some embodiments, cloud based network 150 may be configured to be virtually connected to an API gateway 116 which can receive user input instructions through a user interface 126 and generate instructions for system 102 based on the user input instructions.

Two data processes are proposed that can interoperate with one another, a first data process that is configured to update a client's list of approved withdrawal addresses, and a second data process that uses the list from the first process to process client transactions (e.g., withdrawals).

In the first data process, a computational approach is proposed that allows a message to be signed by the portal system 102 to detail a proposed addition to a client's list of approved withdrawal addresses, which can be printed on a QR code and taken to a vault for validation using a hardware security module 122 on the vault system 104.

In the second data process, the portal system 102 can be used to receive a data message corresponding to a client withdrawal. The portal system 102 exposes previously approved withdrawal addresses as interactive interface elements, and these are used for validation against message digital signatures, and an encrypted address that is decrypted by the HSM 122 and compared against an address in a withdrawal request.

For increased redundancy, the HSMs 112 and 122, in some embodiments, can be configured for recovery of the encryption keys, for example, using specific approaches during the initialization of the HSMs 112 and 122 for backup or redundancy.

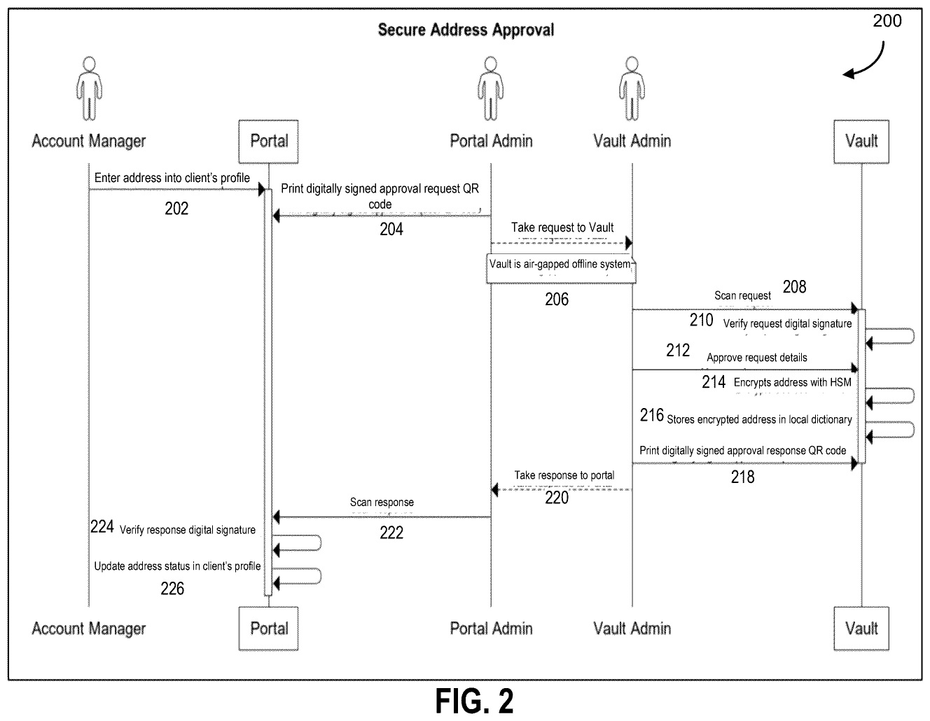

FIG. 2 is an example diagram showing an example secure address approval process, according to some embodiments. Secure address approval process 200 can be established as a data process corresponding to a set of secure data messages that are provided between devices 102 and 104, in accordance with the steps shown in 200. Other, alternate, or different steps are also contemplated.

At 202, an account manager may access the portal system using a graphical user interface, and enter/add an address into a client's profile. This can be an address corresponding to a cryptographic wallet. This message includes fields that detail a proposed addition to a client's list of approved withdrawal addresses.

The portal system 102 can then generate a QR code based on the message, which can then be printed by a portal administrator at 204, who, at 206, physically takes a document or a physical representation thereof to the vault system 104. The representation needs to be brought physically because the vault is an air-gapped offline system.

In some embodiments, the data message has a digital certificate, issued by a certificate authority 106, which is issued and embedded within the QR code. The digital certificate maps the public key, required for verifying the private key associated with a data message signature, to the portal system 102. The digital certificate is used to provide a mechanism for the system 102 and system 104 to validate that the data message was not modified during transport.

In some embodiments, the certificate authority 106 generates a digital certificate comprising a digital signature and public key that is embedded within the data message. The digital certificate is only issued after the certificate authority 106 has verified both the identity of the sending party (i.e. the portal system 102) and the veracity of the public key associated with the sending party. In some embodiments, the certificate authority 106 may be configured to incorporate a time limitation into the issued digital certificates which will cause a currently issued digital certificate to expire and a renewed digital certificate to be issued. The expired digital certificate will no longer be valid evidence of verification for the vault system 104 and the certificate authority 106 may automatically issue a new digital certificate to ensure there is no gap in message security. In some embodiments, upon expiration of a digital certificate, system 102 may generate a data message in the form of a graphical object with a replacement digital certificate from certificate authority 106 embedded within the data message. System 102 may be further configured to be incapable of generating any user data messages for system 104 until the expired digital certificate is replaced.

In some embodiments, system 102 may be configured to restrict transmitting data messages through digital objects to system 104 until certificate authority 106 and system 102 receive a signed response digital object from system 104 validating the status and implementation of the renewed digital certificate.

The certificate authority 106 may be configured to generate a revocation certificate statement which may revoke a currently issued digital certificate. This may occur due to evidence that the currently issued digital certificate has been compromised, that a digital certificate has been issued without proper verification of the system credentials or if a malware threat is detected within the issue certificate. In the event of certificate revocation, system 102 may refrain from generating further graphical object data messages until a response from system 104 is scanned which acknowledges receipt of the revocation and knowledge of the new digital certificate.

In some embodiments, the certificate authority 106 may be an external third party system which is virtually separated from the portal system 102.

The QR code may be printed onto a physical medium or expressed digitally through a user device output display. When the QR code is printed onto a physical medium, the message can be retrieved directly from an output coupled to system 102 or 104. If the QR code is expressed digitally, system 102 may be housed within a cloud based network and the portal interface may be rendered on a user device such as a personal computer or tablet. In this embodiment, the QR code displayed on the user device may be scanned directly from the output display of the user device.

The vault system 104 validates the message's signature by first scanning the request at 208, verifying the request digital signature at 210, and then it can process the request. If the request is approved at 212, the vault system 104 at 214 encrypts the provided address with a key from the hardware security module 122 (HSM) installed in the offline machine. An HSM 122 is used to guarantee security of the cryptographic keys used for encryption operations. An HSM 122 offers a high level of cybersecurity and physical security to prevent exposure of keys. At 216, the encrypted address is stored in a local dictionary on the offline machine (e.g., the vault system 104). It is important to note that the plain-text address is not stored anywhere. This prevents an attacker who has gained access to the vault system 104 (which itself is secured in a high security room with restricted access) from modifying the dictionary of approved withdrawal addresses. Only a signed message from the portal system 102 can update the approved addresses data structure.

The local dictionary can be a local vault dictionary data structure that is stored on non-transitory computer readable memory, and can include a specialized high security storage situation. The local dictionary can be a JSON file that uses a key value pair data structure. In this JSON file, for example, the keys in the key value pair are the hashed client identifiers and withdrawal addresses. The value in the key value pair is the encrypted address that can only be decrypted by the HSM 122.

Accordingly, if one were to observe the JSON file there would not be any identifiable information because of the hashed client ID and the encrypted address.

During initialization, the system 102 issues an X509 certificate that is signed by the Certificate Authority 106 (e.g., a financial institution (FI)'s Root Certificate Authority) in order to secure the communications from the portal 102 to the vault 104. It is a certificate that was signed by the certificate authority 106, and that certificate is used to secure subsequent communications. The system does not necessarily use the FI Root Certificate private key directly, but a certificate that was derived from the Certificate Authority 106.

For the communication of the response from the Vault System 104 to the Portal System 102, the response is signed with a key that was derived from the cryptographic seed phrase used in cryptocurrency transaction signing (not the Certificate Authority 106). The Portal System 102 can validate the integrity of this signature with the extended public key that the Portal System 102 already stores from system initialization.

The HSM 112 is adapted to provide a whitelisting mechanism that, as noted below, can be used in combination with a certificate authority 106 and corresponding root certificates.

In some embodiments, the HSM 112 further enforces a tree structure requirement that is used for the generation of child/grandchild keys, which, for example, can be used for generating secure interactions in the future based on a specific progenitor key without interaction from the vault system 104. From a same seed, a wallet tree can be established for digital assets that use asymmetric key cryptography wallets. For a wallet, a master key, child keys, and grandchild keys can be established using, for example, a branching structure that is generated for each new client that is established. The child keys can be derived on the portal system 102 without interactions with the vault system 104.

The child and grandchild keys within a tree structure associated with a master key (or seed) may each represent a distinct entity or transaction type within the control of a client. The child and grandchild keys, which correspond to a child or grandchild withdrawal address, may be generated without access to the private key stored within the vault system 104. Therefore, once a user has registered a withdrawal address and client identifier within the vault system 104, the user may generate further branching wallet addresses without having to repeat the process described in FIG. 2.

The seed used to generate the branching wallet structure are stored within the HSM 112 and 122 within systems 102 and 104. Therefore, the system 102 may be capable of restoring the accounts of a client using the seed stored within HSM 112 even when vault system 104 is unavailable. Further, system 104 can use the seed stored within HSM 122 associated with a client to generate a digital signature which is embedded within a response digital object transported to system 102. System 102 can then use an extended public key to validate the digital signature from system 104.

In some embodiments, a seed for generating a branching wallet structure may be used by system 102 to generate a wallet tree for individual blockchains. For example, a seed may be generated which derives an initial master wallet for a specific cryptographic currency. This initial wallet may be branched into child wallet addresses derived from the master wallet address which are assigned to a client. Each child wallet may then be further branched to form grandchild wallets which are associated with a specific transaction or type of transaction.

In some embodiments, the initial master wallet address may correspond to an extended master public key which may generate further child and grandchild wallet addresses without having to access the underlying private key(s) associated with the branching wallet structure. Therefore, the process of generating child and grandchild wallets may be performed without exposing the underlying private key(s) associated with the branching wallet structure, resulting in improved security and efficiency.

In some embodiments, the master key may enable the portal system 102 to recover the associated child/grandchild keys without the need to have a secondary back-up on the portal system 104.

For example, the wallet tree structure may utilize a Merkle or hash tree structure where the seed is composed of a top hash which can be branched into a cascading hash structure through a cryptographic hash function. The cryptographic hash function can utilize concatenation to generate branching hashes. The seed may generate two initial branching hash structures which comprise a unique concatenation of the hashes of the seed hash, the two initial branching hash structures will correspond to the master private and public key pair. The child and grandchild keys which branch from the master private and public key pair may be unique hash blocks from the respective parent key in the branch structure.

Once the vault system 104 has processed an address approval request, a response message is generated at 218 along with a digital signature. At 220, this message is printed as a QR code and returned to the portal system 102 (e.g., by carrying the QR code physically) to be scanned at 222.

The digital signature is again used to prevent a man-in-the-middle attack from modifying the message content. At 224, the portal system 102 validates the signature of the response QR code, and at 226, the address status can be updated.

The message can, for example, include a copy of the encrypted address to be backed-up for recovery purposes. It also signifies the completion of the address approval procedure which enables the address to be used for a future withdrawal.

In a practical example, the root certificate can be used in combination with the local address on the local vault dictionary and the HSMs 112 and 122. The approach uses the certificate derived from the Certificate Authority 106 to add signatures to communications from the Portal System 102 to the Vault System 104. It is used to validate all requests that the vault 104 receives, including: wallet Initialization/system initialization, and client initialization. Before the system 102 can create wallets for a client, the system 102 needs to initialize the client in the Vault System 104. The communications to do so are secured via the certificate derived by the Certificate Authority 106. The certificate can also be used for tasks, such as whitelisting addresses to the dictionary and transaction signing.

To expand on Wallet Initialization above, this is the process by which the system generates the seed. The seed is subsequently used to generate wallets for individual blockchains. For example: Seed->Root Wallet for Bitcoin->[Array of Child Wallets (One per client)]->[Array of Grandchild wallets].

The same pattern could be applied to different assets, such as Ethereum, Litecoin, etc. The Array of Child Wallets are the start of branches, and these branches are tied to individual clients (1 branch per client). The branch index is stored in the client's record.

The system can be configured to connect all grandchildren wallets to a child branch to a particular client.

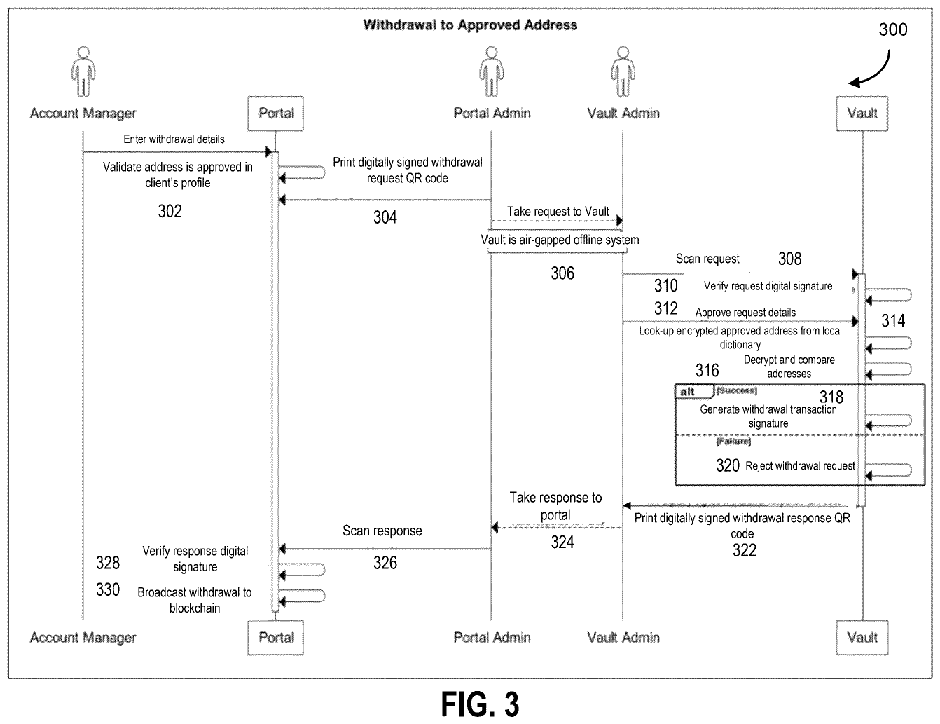

FIG. 3 is an example diagram showing an example withdrawal process 300, according to some embodiments. Secure address approval process 300 can be established as a data process corresponding to a set of secure data messages that are provided between devices 102 and 104, in accordance with the steps shown in 300. Other, alternate, or different steps are also contemplated.

Client withdrawals are initiated in the portal system 102 at 302. Previously approved withdrawal addresses are selectable from the web form. A withdrawal request is generated along with a digital signature, and the withdrawal details are entered. At 304, The client's profile can be used to validate the address by the portal system 102.

The message is printed at 306, and sent (e.g., physically taken) to the vault system 104 at 308. The vault system 104 is used to scan the request at 310, and first validates the message's digital signature at 312. The client ID and withdrawal address in the request are used to perform a look-up at 314 of the encrypted address stored in the local dictionary. The dictionary keys are hashed values to preserve privacy in the event the data structure is exposed. The encrypted address is decrypted by the HSM 122 at 316 and is compared with the address in the withdrawal request. In the event of a match, the withdrawal request is processed at 318. Otherwise, the request is rejected at 320.

The HSM 112 and 122 are configured to provide a secure operating environment for storing private keys and wallet addresses, and for generating cryptographic operations including encryption and decryption of wallet addresses. Further, in some embodiments, the HSM 112 and 122 is configured to authenticate a user request through a combination of a user identifiers and/or digital certificates which is embedded within a digital object and physical scanned by a user through an optical scanner 114 and 124 coupled to the systems 102 and 104 which house the HSM 112 and 122.

In some embodiments, a user identifier may comprise one or more of a PIN, password, private key/signature, physical identifier or smart card. In a further embodiment, HSM 112 and 122 may be configured to require two factor authentication when authenticating a user identifier.

HSM 112 and 122 are configured to provide tamper resistance of the private keys stored within their memory storage through a combination of physical and virtual security measures. HSM 112 and 122 may employ a reinforced physical casing which protects against tampering from a threat actor seeking to gain access to the internal physical components of the hardware. HSM 112 and 122 may be further configured to detect attempts by a threat actor to access the private key storage through fraudulent credentials and log these events for analysis. In a further embodiment, HSM 112 and 122 may be configured to delete the private keys stored within their memory storage in the event of a fraudulent attempt to access the storage medium within the HSM 112 and 122.

When a user inputs a client request into system 102, the request forms the basis of a data message which will be transported to system 104. The data message is parsed into a graphical object which contains a client identifier which is unique to the client which made the request, and a wallet address which is either being registered or transacted with. HSM 112 may be configured to digitally sign the request encoded graphical object using a private key stored within the data memory.

The digital signature generated by the HSM 112 is then verified by the certificate authority 106 to validate that the digital object was generated by system 102. If the certificate authority 106 validates the data message within the graphical object, then a digital certificate is embedded within the data message before it is transported to system 104 to authenticate the identity and signature of system 102.

In some embodiments, the digital signature operates as a security measure against tampering with the data message while it is physically transported between system 102 and 104.

When a graphical object is scanned by an optical scanner 124 coupled to system 104, the data message embedded within the graphical object is received by system 104. The data message may comprise a user request along with a user identifier and wallet address. HSM 122 may be configured to sign the data message received from system 102 with a private key corresponding to the key embedded within the digital certificate to decrypt the data message.

In some embodiments, the user request may be a wallet initialization request to store a wallet address within system 104 as an approved transaction address. In some embodiments, the user request may be a transaction request to transact with one or more of the wallet addresses stored within system 104.

HSM 122 is configured to store wallet addresses within a local dictionary, the wallet addresses being encrypted such that they are unreadable to an external observer. HSM 122 is configured to decrypt an encrypted wallet address. In some embodiments, HSM 122 is the only component within system 100 capable of decrypting the encrypted wallet address. Decryption of the wallet address may be performed through a private key stored within HSM 122, the private key corresponding to a key pair associated with the encrypted wallet address.

In some embodiments, the local dictionary within HSM 122 is a non-transitory computer readable memory configured to include a specialized high security storage situation. The local dictionary may be structured using JSON files that use a branching key value pair data structure. In a further embodiment, the branching keys within the key value pairs stored within the local dictionary may be hashed.

In some embodiments, the HSM 122 is configured to retrieve the data message scanned by the optical scanner 124 and input the client identifier and wallet address from the data message into a look up function. The client identifier and wallet address may correspond to a branched key set within the key value pairs stored within the local dictionary. HSM 122 is configured to locate the set of hashed keys which match the client identifier and wallet address from the data message.

Once the HSM 122 has identified the matching hashed key set, the HSM 122 retrieves from the local dictionary the value in the key value pair which corresponds to the matched hashed key set. The value may be an encrypted wallet address which, upon being decrypted, may match the wallet address received in the data message.

The HSM 122 can decrypt the encrypted wallet address using a private key corresponding to the encrypted wallet address. In some embodiments, the private key can be stored within the HSM 122 and external access of the private key can be completely restricted.

If the decrypted wallet address is found to match the wallet address received in the data message, the HSM 122 is configured to send instructions to processor 120 to generate a response data message for system 104 which verifies that the requested transaction corresponds to an approved wallet address.

In some embodiments, where the user request is for registering a wallet address as an approved address within the HSM 122, the resulting response message will validate that the request has been satisfied.

The response message generated by system 104 may be digitally signed by HSM 122 using a private key corresponding to a public key stored within HSM 112. The private key may be associated with a user identifier and be unique to each user or wallet address initiated within HSM 122.

In some embodiments, the private key(s) stored within HSM 122 may include a master private key which is derived from a seed phrase associated with a wallet tree structure. The master private key being used to digitally sign the response message sent by system 104 and physically transported to system 102. The master private key is configured to form part of a key pair, where the associated extended public key is stored within HSM 112.

In a further embodiment, system 104 generates the response message, which is digitally signed by HSM 122 using the master private key, and the response message is embedded within a graphical object which is made available to a user either through a physical copy or digital copy. The graphical object is physically transported to system 102 where it is scanned by scanner 114 and the embedded response message is validated by the extended public key stored within HSM 112. Validation by the extended public key ensures that the digital signature matches the master private key associated with a user or wallet address stored within HSM 122 and verifies that the response message has not been tampered with while being physically transported to system 102.

In the event the vault system 104 is unavailable whether by inaccessibility or hardware failure, the use of an HSM 112 allows for recovery of the encryption keys used in the address approval process. When initializing an HSM 112 and 122, a set of smart cards can be configured that enable the replication of the cryptographic data on another HSM for backup and redundancy purposes. In this example embodiment, a quorum of these smart cards can be used to initialize a new HSM for use as a hot back-up or in the event of a system failure.

In some embodiments, the certificate authority 106 is used for transaction signing and unsigning using a root certificate stored thereon. The root certificate can be used, for example, to indicate the provenance of a particular transaction. During the scanning of the QR code, the initial source of data can also be validated against, for example, a digital signature from the certificate authority 106. At that point, the HSM 122 can be configured to sign the transaction with the corresponding private key. The private key can be stored on the HSM 122 and never made available outside of the HSM 122.

In some embodiments, the approved withdrawal addresses stored within the local dictionary housed in the HSM 122, may be structured as a key pair comprising a master private and public key. The withdrawal address may correspond to the extended public key and the corresponding master private key may be stored within the HSM 122 of the vault system 104. The master public key may be utilized by system 102 to generate branching wallet addresses all derived from the extended public key.

In some embodiments, the branching wallet addresses may be generated by system 102 using the withdrawal address approved by the process described in FIG. 2 and stored within the local dictionary, without requiring access with the private key(s) associated with the branching wallet structure.

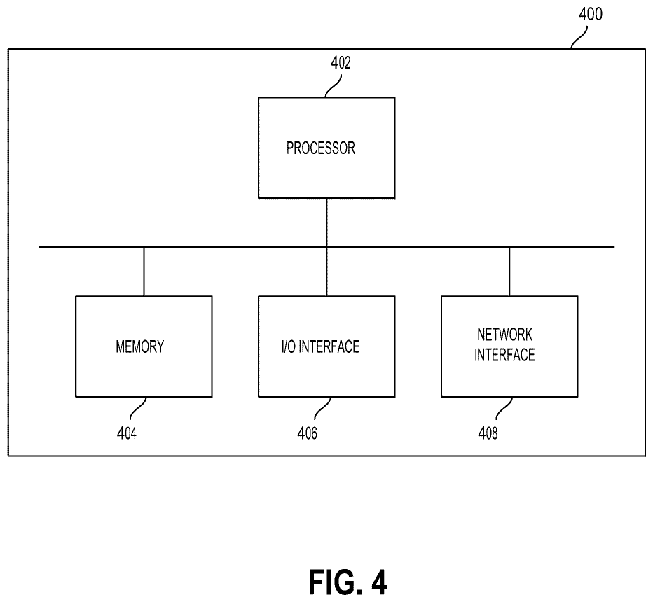

FIG. 4 is a diagram showing an example computer server that can be used to perform steps described in various embodiments herein. Computer 400 includes a computer processor 402, computer memory 404, an input/output interface 406, and a network interface 408.

Processor 402 may be an Intel or AMD x86 or x64, PowerPC, ARM processor, or the like. Memory 404 may include a suitable combination of computer memory that is located either internally or externally such as, for example, random-access memory (RAM), read-only memory (ROM), compact disc read-only memory (CDROM).

Each I/O interface 406 enables computing device 400 to interconnect with one or more input devices, such as a keyboard, mouse, camera, touch screen and a microphone, or with one or more output devices such as a display screen and a speaker.

Each network interface 408 enables computing device 400 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

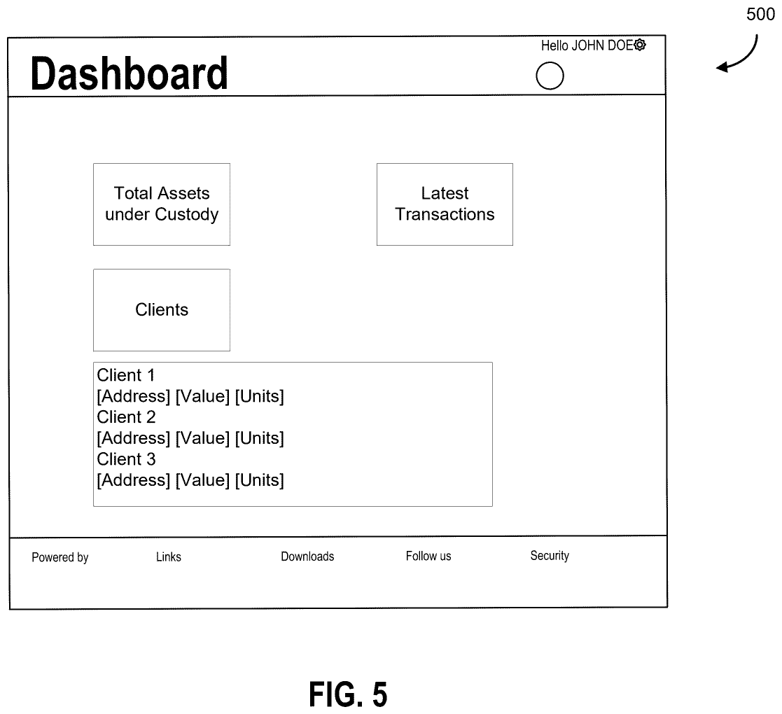

FIG. 5 is an example screenshot of an example dashboard, according to some embodiments. In the dashboard 500, a number of approved clients are shown to the user that the user can pick from for future transactions. The clients are approved using the process of FIG. 2.

The dashboard 500 is displayed through a user interface 126 that is rendered on an interactive display which can receive inputs from a user through a terminal. The dashboard 500 may be configured to communicate with a processor and retrieve personalized information regarding the client which is stored within a memory device. For example, the dashboard 500 may display renderings of metrics and metadata relating to the assets and transactions which are associated with the user and their wallets.

System 102 is configured to comprise a processor 110 which contains machine readable instructions for controlling the display device to render the dashboard 500 and user transaction information.

Upon a user selecting a withdrawal address associated with a client, system 102 may be configured to generate a withdrawal request which has been signed by the certificate authority 106. The withdrawal request is stored within a digitally signed withdrawal request encoded graphical object such as a QR code which can be scanned and validated by the system 104.

In some embodiments, the user may interact with the user interface displaying the dashboard 500 through an input device such as a mouse, touch screen or keyboard which is communicatively coupled to a terminal.

System 102 may generate the graphical object through an output such as a printer or hardware connection point. In some embodiments, system 102 may print the digitally signed withdrawal request encoded graphical object and a user will manually transport the message to system 104. In another embodiment, system 102 may generate a copy of the digitally signed withdrawal request encoded graphical object which can be displayed through a graphical user interface 126 on a client output device. For example, user may receive a digital copy of the digitally signed withdrawal request encoded graphical object on their cellular/mobile device, tablet, laptop, smart device and the like, and transport the digital copy to system 104.

In some embodiments, when a user inputs a command into the dashboard 500, a withdrawal address is retrieved by the system 102 and validated against the client profile. The withdrawal address must be one of the previously approved withdrawal addresses, which requires that the system 104 has communicated an update to system 102 to update the address status to “approved” on the client profile.

Once the withdrawal request has been generated by the system 102 in response to an input by the user, system 102 may be configured to generate a graphical object which includes the transaction details and a digital signature unique to system 102.

The digitally signed withdrawal request graphical object signature is physically transported to a separate location housing the computing architecture of system 104. The location of system 104 may be physically secured through techniques such as individual physical identification including providing government I.D, providing a unique scannable identifier, user specific passwords, two factor authentication, or proof of digital signature from system 102.

Once an individual gains access to the secure location of system 104, the digitally signed withdrawal request graphical object may be presented to system 104 either as a physical print-out or on a user digital output device. System 104 may be configured to scan the graphical object and verify that a digital signature from system 102 is present and unmodified. In some embodiments, a physical optical scanner is either embedded within system 104 or is electrically coupled to system 104, the physical optical scanner may be configured to scan the graphical object and transmit the associated data message to the one or more processors within system 104.

To complete the transaction, system 104 may be configured to parse the data message from the scanned graphical object and perform a look up within the local dictionary stored in a memory device within system 104. The addresses stored within the local dictionary may be encrypted, including through hashing, such that even if the local dictionary was accessed fraudulently, the hashed entries would be incapable of being associated with a withdrawal address without further decryption by the private key stored within HSM 122.

System 104 may be configured to combine the user ID and withdrawal address retrieved from the graphical object to generate a search query for a lookup function within the local dictionary. If a hashed data object within the local dictionary is identified, the HSM 122 of system 104 may decrypt the hashed data object to generate a withdrawal address which can be compared to the withdrawal address retrieved from the digitally signed withdrawal request graphical object. The system 104 may be configured to compare the decrypted withdrawal address and retrieved withdrawal address, and identify if a match is present. If a match is present, the withdrawal request will be processed by system 104 and a withdrawal response graphical object will be presented to the user. The withdrawal response graphical object may be embedded with a digital signature associated with system 104, which will be verified by system 102 when the withdrawal response is scanned.

A user may physically transport the withdrawal response, either on a printed medium or through a digital output device, to system 102. System 102 may scan the graphical object and verify that a digital signature from system 104 is present and unmodified. If the withdrawal request is verified, system 102 may be configured to broadcast the transaction data to a corresponding blockchain node to record the transaction.

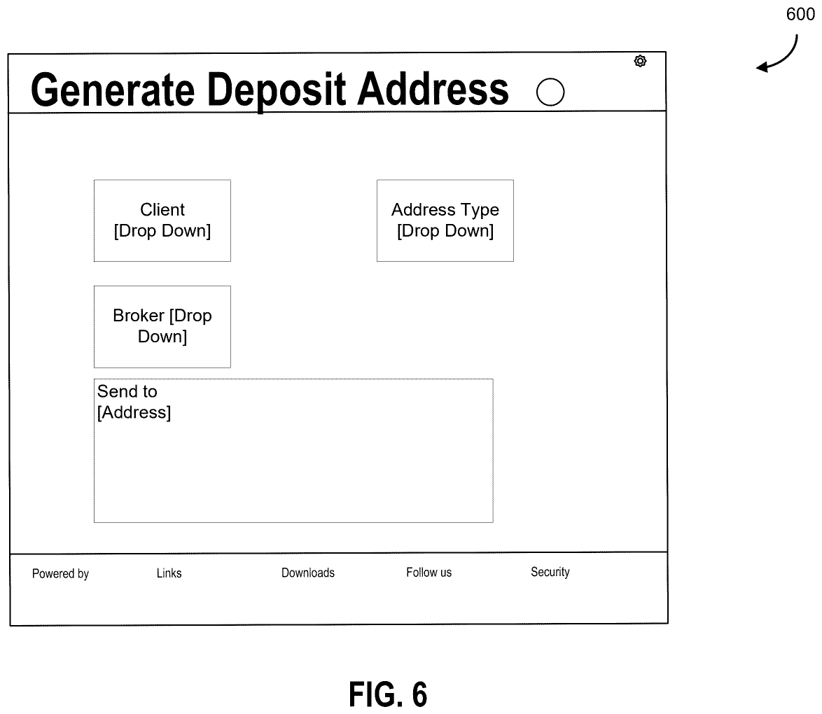

FIG. 6 is an example display of an example approach for generating a deposit address, according to some embodiments. In the display 600, an approach is used for generating a new deposit address using the process of FIG. 2.

Similar to FIG. 5, the display 600 shown in FIG. 6 may have a user interface rendered on an interactive display which can receive inputs from a user through a terminal. A user, such as an account manager, may input through a graphical user interface 126, an address which will be used for future transactions. In some embodiments, the address may be for a cryptographic wallet including a desktop wallet, web based wallet, and a mobile wallet.

Upon the address being added to the client profile on the portal interface 126 of system 102, a graphical object may be generated which contains a data message requesting a new address to be registered with a client profile. In some embodiments, the data message request may modify an existing address registered with the client profile.

The graphical object may be digitally signed by the certificate authority 106 to provide an added layer of security against modifications which could occur to the data message while being transported to system 104. The digitally signed data message includes fields that detail a proposed addition or modification to a client's list of approved withdrawal addresses.

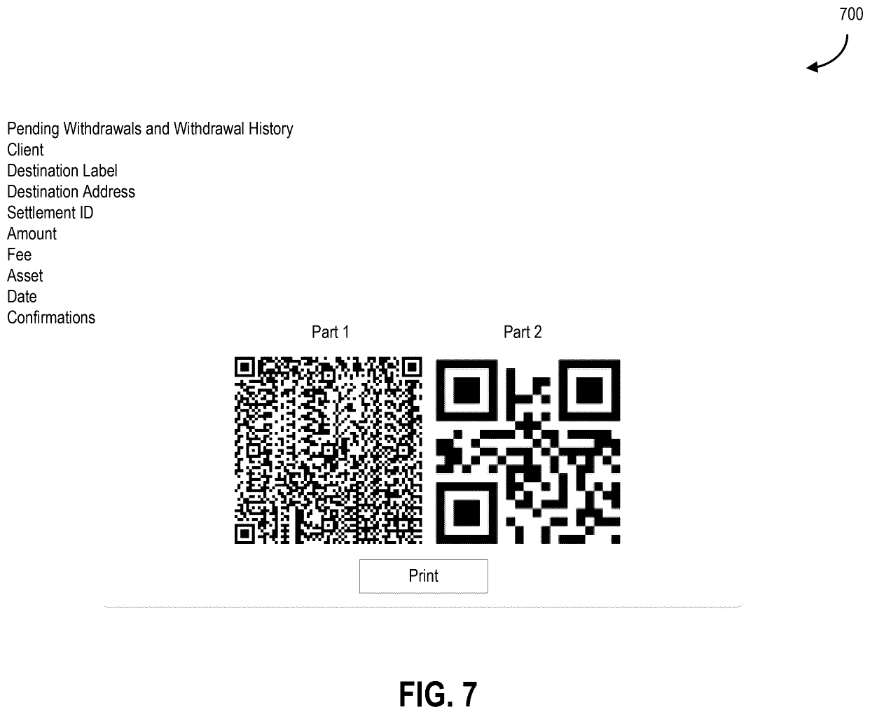

FIG. 7 is a screenshot of example QR codes generated for interaction with the vault server, according to some embodiments. In diagram 700, two QR codes are shown.

In some embodiments, the QR code is used for establishing an approval request and are embedded with a data message containing a wallet address which is associated with an approval request which will be verified and stored within the local dictionary. The system 104 may be configured to receive the QR code, and its corresponding approval request, and upon verifying that the digital certificate corresponds to a digital certificate generated by the certificate authority server 106, storing the wallet address within the local dictionary.

In some embodiments, the QR code is used for establishing an approval request and are embedded with a data message containing a wallet address which is associated with an approval request which will be verified and stored within the local dictionary. The system 104 may be configured to receive the QR code, and its corresponding approval request, and upon verifying that the digital certificate corresponds to a digital certificate generated by the certificate authority server 106, storing the wallet address within the local dictionary.

In some embodiments, the QR codes are scanned by physical optical scanners embedded or electrically coupled within the system 102 and 104. In some embodiments, the QR code may contain a data message and digital signature corresponding to either system 102 or 104, the digital signature acting as a certificate that the data packet embedded in the QR code has not been tampered with during transport between systems 102 and 104.

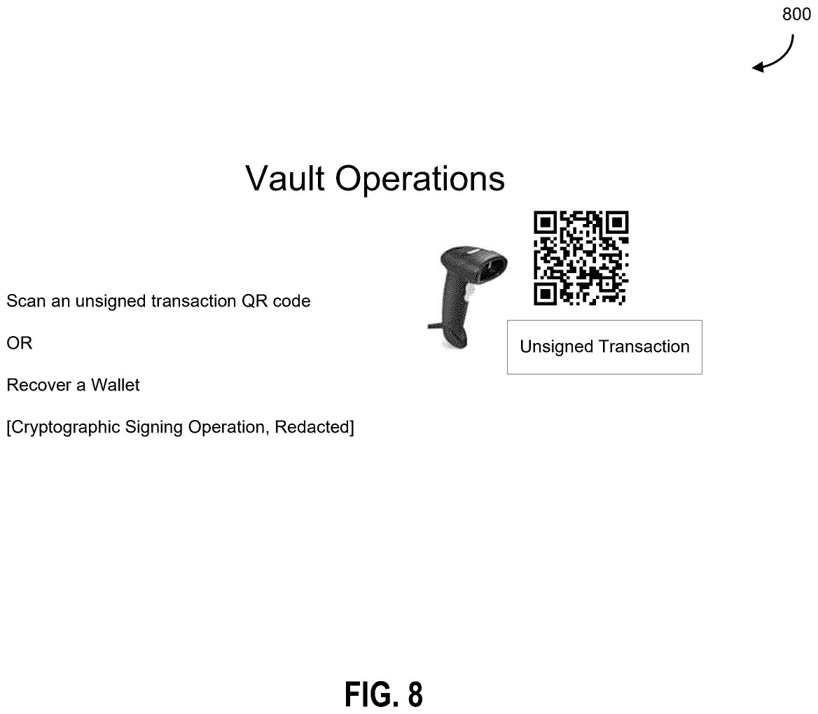

FIG. 8 is an example process diagram for a process that can be conducted on the vault system, according to some embodiments. In FIG. 8, diagram 800 shows a vault scanner that can sign a transaction code to start an interaction on the vault system. In some embodiments, the system can also be configured to initiate a wallet recovery process.

In some embodiments, the vault scanner in diagram 800 may be a physical optical scanner or camera. When the vault scanner is a physical optical scanner, a user may operate the scanner by scanning the graphical object containing a data message from the portal system 102. The physical optical scanner may detect whether the QR code is a valid object and transmit the data message to the vault system 104.

In some embodiments, the physical optical scanner may reject QR codes which are invalid and generate a message to the user which states that no information is detectable.

In some embodiments, the physical optical scanner may decode the graphical object and retrieve at least the client identifier, a withdrawal address, and a digital certificate. The retrieved data is transmitted to the vault system 104 where it is validated and forms the basis for the look up function within the local dictionary.

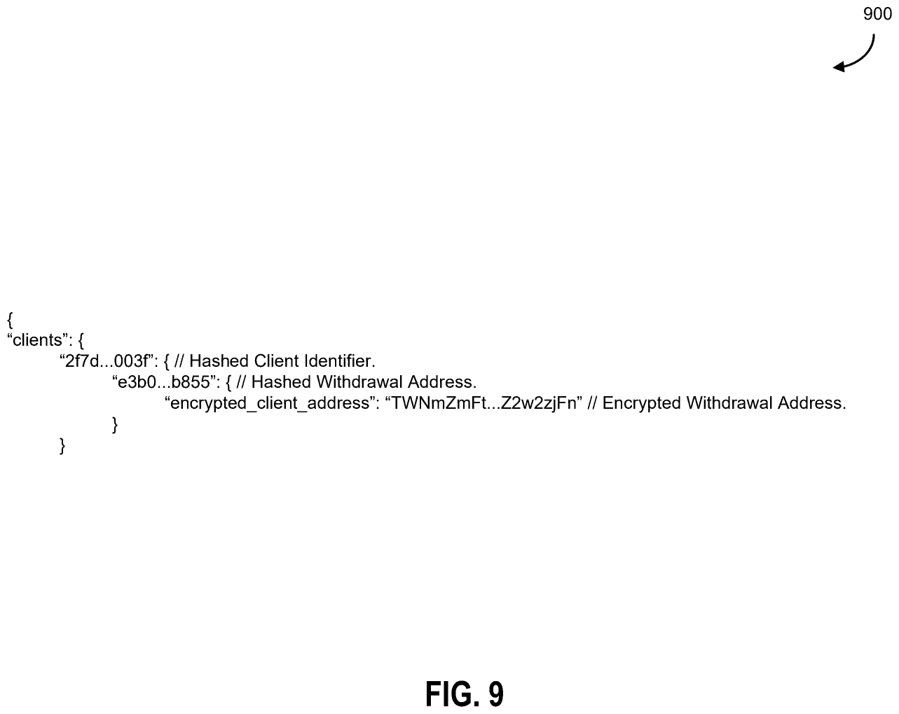

FIG. 9 is an example JSON dictionary data structure 900, according to some embodiments.

Data structure 900 may be composed of a plurality of key-value pairs which are composed of an object having a nested string structure with three properties. The client object in data structure 900 contains two keys composed of the hashed client identifier and hashed withdrawal address. When a user submits a withdrawal request graphical object for scanning by system 104, the data message within the graphical object may contain a client identifier and withdrawal address which may be mapped to the matching keys within the local dictionary.

For example, a client object may have a single hashed client identifier which allows system 104 to map a received client identifier to the corresponding client object. Within the client object, the hashed client identifier may have a plurality of nested hashed withdrawal addresses which correspond to the withdrawal addresses which have been verified and approved during an earlier data messaging process between systems 102 and 104. The received withdrawal address from the signed user transaction request may be mapped to one of the nested hashed withdrawal addresses by the QR code reader 124. If a client object is identified with both a matched client identifier key and withdrawal address key, then the processor 120 may be configured to retrieve the corresponding encrypted withdrawal address value of the key-value pair. The encrypted withdrawal address may be a string which can only be decrypted by the HSM 122, the decrypted withdrawal address is then able to be compared to the received withdrawal address to verify if a match is present. If HSM 122 verifies a match between the decrypted withdrawal address and received withdrawal address, then system 104 may generate a withdrawal response graphical object which certifies that the transaction is associated with an approved withdrawal address. The withdrawal response may be digitally signed using a signature generated by the certificate authority 106 which corresponds to the request digital signature initially validated by system 104. The withdrawal response graphical object may be physically transported to system 104 to complete the transaction.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present application is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

What is claimed is:

1. A computer system configured for secure cryptographic address approval, the system comprising:
a first computing device configured as a portal system having a first hardware security module;
a second computing device configured as a vault system having a second hardware security module, the second computing device physically and virtually segregated from the first computing device such that the first computing device is unable to electronically communicate directly with the second computing device;
the first computing device configured to:
receive a data message to enter an address into a client profile;
generate a digitally signed approval request encoded graphical object, the digitally signed approval request encoded graphical object signed by a key on the first hardware security module;
the second computing device configured to:
receive the digitally signed approval request encoded graphical object;
verify the digitally signed approval request encoded graphical object;
encrypt the address into a local dictionary stored on the second hardware security module; and
generate a digitally signed approval response encoded graphical object for scanning by the first computing device, the first computing device verifying the digitally signed approval response encoded graphical object, updating an address status corresponding to the address on the client profile.

2. The computer system of claim 1, wherein the digitally signed approval request encoded graphical object and the digitally signed approval response encoded graphical object are quick response (QR) codes.

3. The computer system of claim 1, wherein the verification of the digitally signed approval request encoded graphical object or the digitally signed approval response encoded graphical object include verification of digital certificates against one or more digital certificates generated by a certificate authority server.

4. The computer system of claim 1, wherein the address stored into the local dictionary stored on the second hardware security module is an address based on an encryption key pair, and the address can be utilized to generate one or more child keys by the first computing device, which can be utilized for withdrawals to the address.

5. The computer system of claim 1, wherein the first computing device and the second computing device are configured to interoperate to process a withdrawal to the address.

6. The computer system of claim 5, wherein to process the withdrawal to the address, the first computing device receives a withdrawal message that is validated against the client profile, generates a digitally signed withdrawal request graphical object; the second computing device receives the digitally signed withdrawal request graphical object for scanning and verification, and upon verification of the digitally signed withdrawal request graphical object, looks up the address on the local dictionary for generating a withdrawal transaction signature and printing of a digitally signed withdrawal response graphical object; and the first computing device receives and verifies the digitally signed withdrawal response graphical object for broadcasting to a corresponding blockchain node.

7. The computer system of claim 6, wherein the digitally signed withdrawal request graphical object and the digitally signed withdrawal response graphical object are quick response (QR) codes.

8. The computer system of claim 6, wherein the look up of the address includes matching the address or a child key associated with the address against the address.

9. The computer system of claim 8, wherein matching the child key associated with the address includes matching a pre-generated set of keys corresponding to an encryption branch associated with the address generated proximate to an initial adding of the address to the local dictionary of the second hardware security module.

10. The computer system of claim 7, wherein the QR codes are scanned by physical optical scanners.

11. A computer method for secure cryptographic address approval, using a first computing device configured as a portal system having a first hardware security module and a second computing device configured as a vault system having a second hardware security module, the second computing device physically and virtually segregated from the first computing device such that the first computing device is unable to electronically communicate directly with the second computing device, the method comprising:
receiving, by the first computing device, a data message to enter an address into a client profile;
generating, by the first computing device a digitally signed approval request encoded graphical object, the digitally signed approval request encoded graphical object signed by a key on the first hardware security module;
receiving, the second computing device, the digitally signed approval request encoded graphical object;
verifying, the second computing device, the digitally signed approval request encoded graphical object;
encrypting, the second computing device, the address into a local dictionary stored on the second hardware security module; and
generating, the second computing device, a digitally signed approval response encoded graphical object for scanning by the first computing device, the first computing device verifying the digitally signed approval response encoded graphical object, updating an address status corresponding to the address on the client profile.

12. The computer method of claim 11, wherein the digitally signed approval request encoded graphical object and the digitally signed approval response encoded graphical object are quick response (QR) codes.

13. The computer method of claim 11, wherein the verification of the digitally signed approval request encoded graphical object or the digitally signed approval response encoded graphical object include verification of digital certificates against one or more digital certificates generated by a certificate authority server.

14. The computer method of claim 11, wherein the address stored into the local dictionary stored on the second hardware security module is an address based on an encryption key pair, and the address can be utilized to generate one or more child keys by the first computing device, which can be utilized for withdrawals to the address.

15. The computer method of claim 11, wherein the first computing device and the second computing device are configured to interoperate to process a withdrawal to the address.

16. The computer method of claim 15, wherein to process the withdrawal to the address, the first computing device receives a withdrawal message that is validated against the client profile, generates a digitally signed withdrawal request graphical object; the second computing device receives the digitally signed withdrawal request graphical object for scanning and verification, and upon verification of the digitally signed withdrawal request graphical object, looks up the address on the local dictionary for generating a withdrawal transaction signature and printing of a digitally signed withdrawal response graphical object; and the first computing device receives and verifies the digitally signed withdrawal response graphical object for broadcasting to a corresponding blockchain node.

17. The computer method of claim 16, wherein the digitally signed withdrawal request graphical object and the digitally signed withdrawal response graphical object are quick response (QR) codes.

18. The computer method of claim 16, wherein the look up of the address includes matching the address or a child key associated with the address against the address.

19. The computer method of claim 18, wherein matching the child key associated with the address includes matching a pre-generated set of keys corresponding to an encryption branch associated with the address generated proximate to an initial adding of the address to the local dictionary of the second hardware security module.

20. A non-transitory computer readable memory, storing machine-interpretable instructions, which when executed by one or more processors, cause the one or more processors to perform a computer implemented method for secure cryptographic address approval, using a first computing device configured as a portal system having a first hardware security module and a second computing device configured as a vault system having a second hardware security module, the second computing device physically and virtually segregated from the first computing device such that the first computing device is unable to electronically communicate directly with the second computing device, the method comprising:
receiving, by the first computing device, a data message to enter an address into a client profile;
generating, by the first computing device a digitally signed approval request encoded graphical object, the digitally signed approval request encoded graphical object signed by a key on the first hardware security module;
receiving, the second computing device, the digitally signed approval request encoded graphical object;
verifying, the second computing device, the digitally signed approval request encoded graphical object;
encrypting, the second computing device, the address into a local dictionary stored on the second hardware security module; and
generating, the second computing device, a digitally signed approval response encoded graphical object for scanning by the first computing device, the first computing device verifying the digitally signed approval response encoded graphical object, updating an address status corresponding to the address on the client profile.
